(19) United States
(12) Patent Application Publication
(10) Pub. No.: US 2023/0393871 A1
(43) Pub. Date: Dec. 7, 2023

(54) METHOD AND SYSTEM OF INTELLIGENTLY GENERATING HELP DOCUMENTATION

(71) Applicant: Microsoft Technology Licensing, LLC, Redmond, WA (US)

(72) Inventors: Tomasz Lukasz RELIGA, Seattle, WA (US); Huitian JIAO, Snoqualmie, WA (US); Max WANG, Seattle, WA (US)

(73) Assignee: Microsoft Technology Licensing, LLC, Redmond, WA (US)

(21) Appl. No.: 17/833,340

(22) Filed: Jun. 6, 2022

(51) Int. Cl. G06F 9/451; G06F 8/73

(52) U.S. Cl. CPC G06F 9/453; G06F 8/73

(57) ABSTRACT

A system and method for automatically generating help documentation for an application includes examining telemetry data associated with a plurality of users' use of the application and identifying from the telemetry data an intended action for which a help documentation should be generated. Upon identifying the intended action, an action path in the application for arriving at the intended action may be determined where the action path includes one or more actions taken before arriving at the intended action and an action label for each of the actions may be identified. The action path and the action label may be provided to a trained machine-learning (ML) model for automatically generating the help documentation and in response, an automatically generated help documentation may be received as an output.

### BACKGROUND

Many of today's software applications include numerous features and options for performing various actions, in order to help users learn about these features and discover how to perform various functions, many software applications offer documentation and help articles on different topics and application features, Creating such help articles, however, is time-consuming and challenging. Moreover, many software applications undergo agile development and experimentation, thus requiring quick development and/or changes to help documentation.

Furthermore, features are continuously being added, removed or updated in software applications. When a change to a feature is made, a previously created help article associated with the feature may no longer be applicable. With the number of features offered by many software applications and the frequency with which features are changed, keeping track of feature changes and maintaining comprehensive and up-to-date help documentations becomes a very complex and challenging task. This task often requires substantial human intervention from a group of developers who are well-versed in the workings of the software application and have expertise in creating help documentation. This is a timely and cost extensive process, and because of the complexities and number of people involved may result in inconsistent, incomplete, outdated or inaccurate help documentation.

Hence, there is a need for improved systems and methods of intelligently generating help documentation.

### SUMMARY

In one general aspect, the instant disclosure presents a data processing system having a processor and a memory in communication with the processor wherein the memory stores executable instructions that, when executed by the processor, cause the data processing system to perform multiple functions. The function may include examining telemetry data associated with a plurality of users' use of an application, identifying from the telemetry data an intended action for which a help documentation should be generated, determining from the telemetry data an action path in the application for arriving at the intended action, the action path including one or more actions taken before arriving at the intended action, identifying an action label for at least one of the one or more actions, providing at least one of the action path and the action label to a trained machine-learning (ML) model for automatically generating the help documentation, and receiving from the trained ML model the automatically generated help documentation as an output.

In yet another general aspect, the instant disclosure presents a method for automatically generating help documentation for an application. In some implementations, the method includes examining telemetry data associated with a plurality of users' use of the application, identifying from the telemetry data an intended action for which a help documentation should be generated, determining from the telemetry data an action path in the application for arriving at the intended action, the action path including one or more actions taken before arriving at the intended action, identifying an action label for at least one of the one or more actions, providing at least one of the action path and the action label to a trained machine-learning (ML) model for automatically generating the help documentation, and receiving from the trained ML model the automatically generated help documentation as an output.

In a further general aspect, the instant application describes a non-transitory computer readable medium on which are stored instructions that when executed cause a programmable device to perform function of examining telemetry data associated with a plurality of users' use of an application, identifying from the telemetry data an intended action for which a help documentation should be generated, determining from the telemetry data an action path in the application for arriving at the intended action, the action path including one or more actions taken before arriving at the intended action, identifying an action label for at least one of the one or more actions, providing at least one of the action path and the action label to a trained machine-learning (ML) model for automatically generating the help documentation, and receiving from the trained ML model the automatically generated help documentation as an output.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A depicts an example system upon which aspects of this disclosure may be implemented.

FIG. 1B depicts an example data flow between some elements of an example system upon which aspects of this disclosure may be implemented.

FIG. 1C how one or more ML models used by a help documentation management system may be trained.

FIG. 2 depicts an example UI screen of different user interface elements used to perform an action in an application.

FIG. 3 depicts an example action path, corresponding action labels and a resulting help documentation generated.

FIG. 4 is a flow diagram depicting an exemplary method for automatically generating help documentation for software applications.

FIG. 5 is a block diagram illustrating an example software architecture, various portions of which may be used in conjunction with various hardware architectures herein described.

FIG. 6 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

It is common for complex software applications to offer help documentation to assist users in determining how to perform certain actions. Creating the help documentation often requires having a clear understanding of the functionalities of the software application, as well as having expertise in writing concise instructional articles. For complex software applications having many different features, this often requires extensive human intervention by several different people, Because different people have different writing styles, this can lead to inconsistencies in the formatting and language of the help documentations. Furthermore, creating help documentation for numerous software application features requires extensive time and resources. This is made more complex by frequent changes and updates to software programs that may involve adding, removing and/or updating various features. Keeping track of all the changes and constantly revising the documentation in response to the changes is not only expensive and time-consuming, but also impractical for many complex applications. This often results in out-of-date help documentation. Thus, there exists a technical problem of current mechanisms for creating software application help documentations being inefficient, costly, difficult to maintain and leading to inconsistencies between various help documentations.

To address these technical problems and more, in an example, this description provides technical solutions for intelligently generating help documentation for a software application based on telemetry data of actual use of the application. This may involve collecting telemetry data of usage of an application, analyzing the telemetry data to identify action paths and/or action labels associated with performing various actions in the application, and using a machine-learning (ML) to generate a help documentation for the actions based on an identified action path and/or action label. Action path may refer to a set of commands that are used or actions that are taken in the application to perform a specific intended action. Action label may refer to user interface (UI) elements used to perform each command. The ML model used to generate the help documentation may be a prompt-based trained model that directly predicts probability of text to perform the prediction task of generating a help documentation. Input to the model may be modified using one or more templates that turn the input into a textual string prompt to generate the help documentation. The technical solution may further involve monitoring telemetry data for any changes to existing action paths, and automatically generating new help documentation, when changes are detected. These changes could be monitored segmented by software version, locale or others, to ensure that each software variant is up to date with respect to the help documentation needed to use it. In this manner, the technical solutions provide an automatic help documentation generation and maintenance system that can quickly and efficiently generate help documentation, identify when changes to an existing help documentation are needed and automatically replace the existing help documentation when change is needed. This minimizes the amount of manual intervention required, thus increasing the accuracy and consistency of help documentations and increasing customer satisfaction.

As will be understood by persons of skill in the art upon reading this disclosure, benefits and advantages provided by such implementations can include, but are not limited to, a technical solution to the technical problems of lack of mechanisms for efficient and accurate generation of help documentation for software applications. The technical solutions enable automatic generation of help documents based on collected usage data. This not only eliminates or reduces the need for human intervention, but also results in higher quality help documentation, as frequent users of software applications may have more expertise in use of the applications than commissioned writers of help documentations. Furthermore, automatic generation of help documentation ensures consistency across many help documentations, thus increasing customer satisfaction. Moreover, by monitoring user actions, the technical solution enables automatic maintenance and updating of help documentation, when changes are made to the software application. In this manner, the technical solution minimizes manual input and improves the operation and efficiency of computer systems. The technical effects at least include (1) improving the efficiency and accuracy of generating help documentation for software applications; and (2) improving the efficiency of maintaining and updating help documentation by enabling generation of help documentation in real-time.

As used herein, the terms “application,” and “software application” may refer to any software program that provides options for performing various tasks. The term “action,” “feature” or “application feature” may refer to any command or action offered by an application for performing a task. Furthermore, the term “help documentation” or “help article” may refer to a set of instructions or steps for performing an intended action in an application.

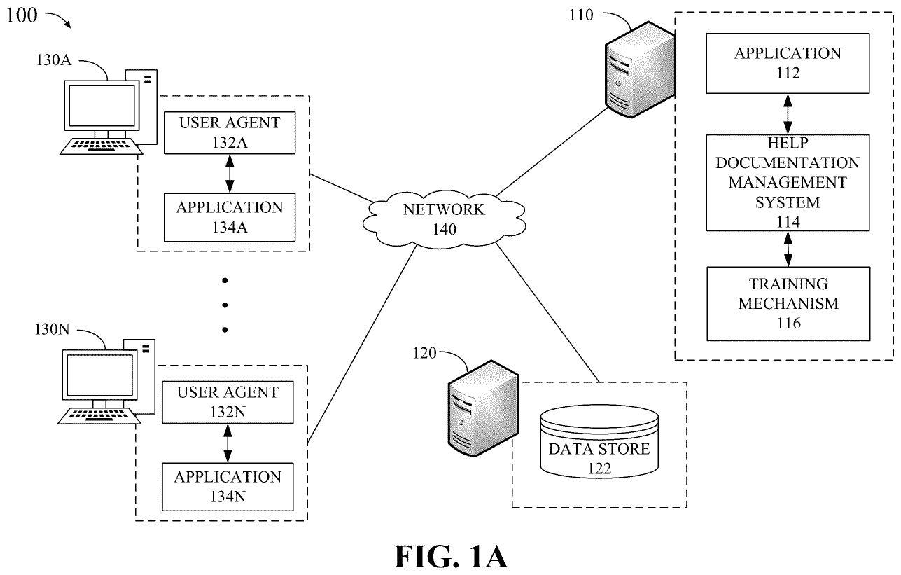

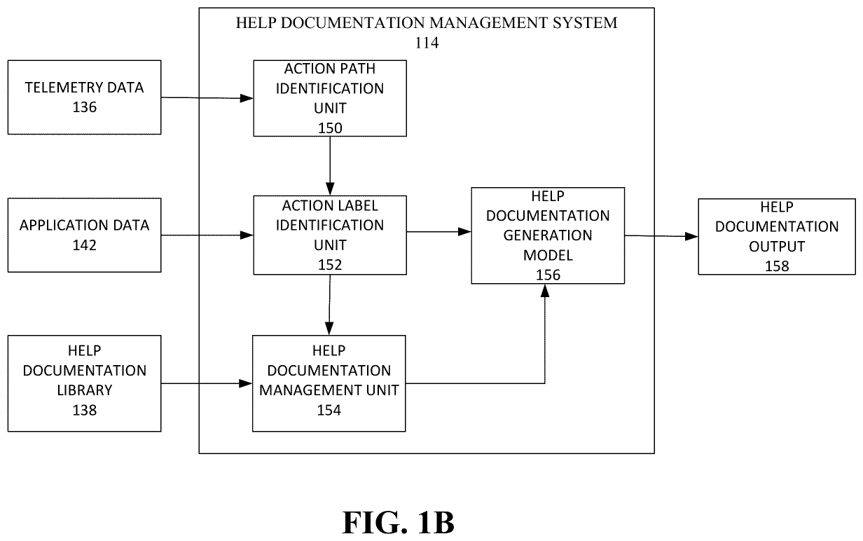

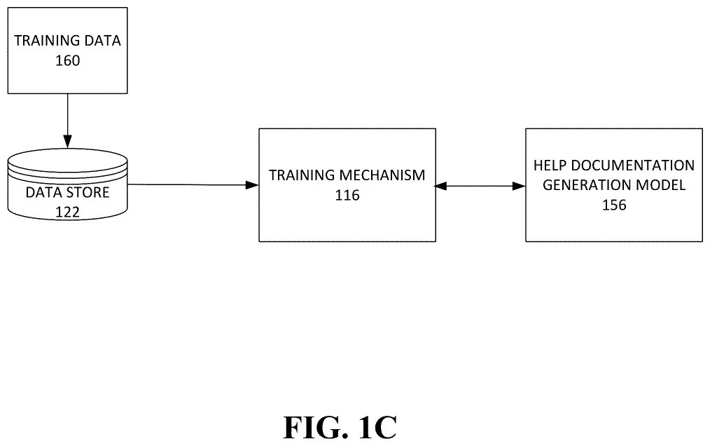

FIG. 1A illustrates an example system 100, upon which aspects of this disclosure may be implemented. The system 100 may include a server 110, which may itself include an application 112, a help documentation management system 114 and a training mechanism 116. While shown as one server, the server 110 may represent a plurality of servers that work together to deliver the functions and services provided by each engine or application included in the server 110. The server 110 may operate as a shared resource server located at an enterprise accessible by various computer client devices such as a client devices 130A-130N. The server 110 may also operate as a cloud-based server for help documentation management services for one or more applications such as application 112 and/or application 134.

The server 110 may include and/or execute a help documentation management system 114, which may monitor telemetry logs collected from users' use of an application such as the application 112 or 134 and may analyze the collected telemetry logs to identify action paths for arriving at various actions. The help documentation management system 114 may examine the identified action path and retrieve information from source code or other resources to identify action labels that correspond with each action in an identified action path. Once an action path and action labels associated with different steps of the action path have been determined, the help documentation management system 114 may utilize one or more ML models to automatically generate help documentation (e.g., a help article) for performing the action. Furthermore, the help documentation management system 114 may examine the collected telemetry logs to detect changes to previously identified action paths and/or identify new actions for which help documentation is not available, and automatically generate new help documentation, when changes/new actions are detected. These actions may be performed by utilizing one or more ML models, as discussed in greater detail with respect to FIG. 1B.

One or more ML models implemented by the help documentation management system 114 may be trained by the training mechanism 116. The training mechanism 116 may use training data sets stored in the data store 122 to provide initial and ongoing training for each of the models. Alternatively, or additionally, the training mechanism 116 may use training data sets from elsewhere. In some implementations, the training mechanism 116 uses labeled training data to train one or more of the models via deep neural network(s) or other types of ML models. The initial training may be performed in an offline stage.

As a general matter, the methods and systems described herein may include, or otherwise make use of one or more ML model to generate help documentation and/or identify changes in application features. ML generally involves various algorithms that can automatically learn over time. The foundation of these algorithms is generally built on mathematics and statistics that can be employed to predict events, classify entities, diagnose problems, and model function approximations. As an example, a system can be trained using data generated by a ML model in order to identify patterns in help documentations, determine associations between various words and action labels, and generate text. Such training may be made following the accumulation, review, and/or analysis of data over time. Such data is configured to provide the ML algorithm (MLA) with an initial or ongoing training set. In addition, in some implementations, a user device can be configured to transmit data captured locally during use of relevant application(s) to a local or remote ML algorithm and provide supplemental training data that can serve to fine-tune or increase the effectiveness of the MLA. The supplemental data can also be used to improve the training set for future application versions or updates to the current application.

In different implementations, a training system may be used that includes an initial ML model (which may be referred to as an “ML model trainer”) configured to generate a subsequent trained ML model from training data obtained from a training data repository or from device-generated data. The generation of both the initial and subsequent trained ML model may be referred to as “training” or “learning.” The training system may include and/or have access to substantial computation resources for training, such as a cloud, including many computer server systems adapted for machine learning training. In some implementations, the ML model trainer is configured to automatically generate multiple different ML models from the same or similar training data for comparison. For example, different underlying MLAs, such as, but not limited to, decision trees, random decision forests, neural networks, deep learning (for example, convolutional neural networks), support vector machines, regression (for example, support vector regression, Bayesian linear regression, or Gaussian process regression) may be trained. As another example, size or complexity of a model may be varied between different ML models, such as a maximum depth for decision trees, or a number and/or size of hidden layers in a convolutional neural network. Moreover, different training approaches may be used for training different ML models, such as, but not limited to, selection of training, validation, and test sets of training data, ordering and/or weighting of training data items, or numbers of training iterations. One or more of the resulting multiple trained ML models may be selected based on factors such as, but not limited to, accuracy, computational efficiency, and/or power efficiency. In some implementations, a single trained ML model may be produced.

The training data may be occasionally updated, and one or more of the ML models used by the system can be revised or regenerated to reflect the updates to the training data. Over time, the training system (whether stored remotely, locally, or both) can be configured to receive and accumulate more training data items, thereby increasing the amount and variety of training data available for ML model training, resulting in increased accuracy, effectiveness, and robustness of trained ML models.

In collecting, storing, using and/or displaying any user data used in training ML models or analyzing telemetry logs, care may be taken to comply with privacy guidelines and regulations. For example, options may be provided to seek consent (e.g., opt-in) from users for collection and use of user data, to enable users to opt-out of data collection, and/or to allow users to view and/or correct collected data.

The system 100 may include a server 120 which may be connected to or include the data store 122 which may function as a repository in which databases relating to training models, telemetry logs and/or help documentations may be stored. Although shown as a single data store, the data store 122 may be representative of multiple storage devices and data stores which may be accessible by one or more of the help documentation management system 114, training mechanism 116, and applications 112/134.

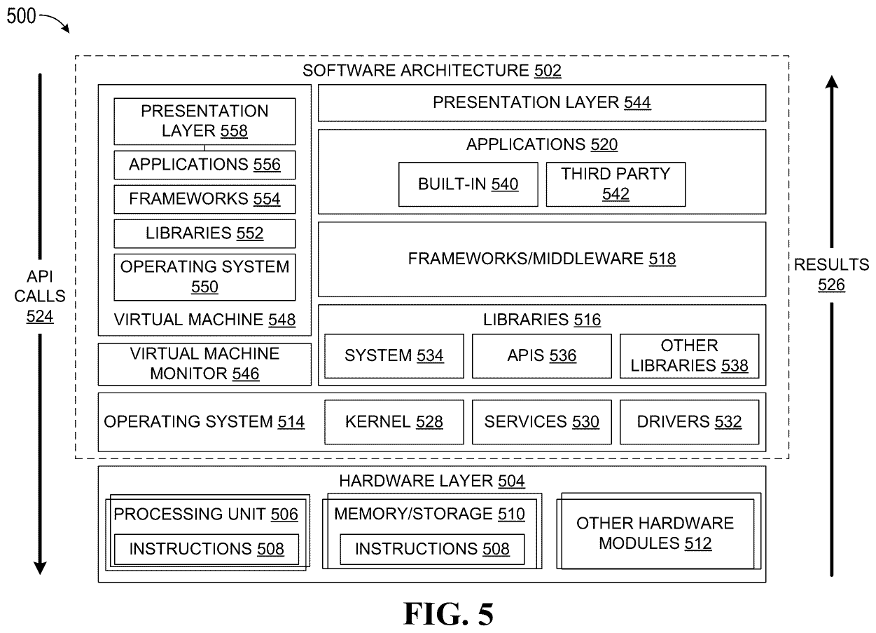

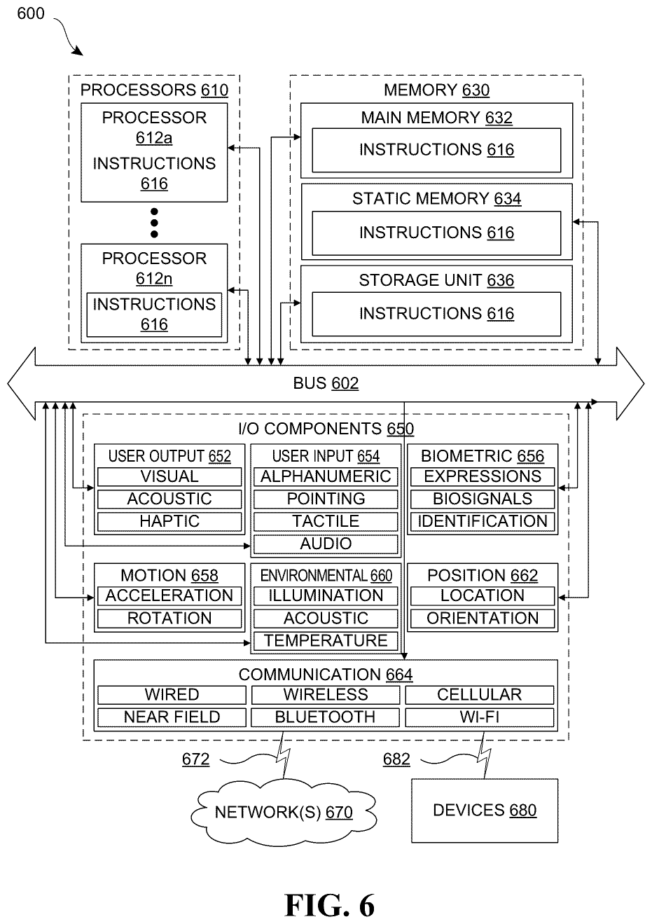

The client devices 130A-130N may be connected to the server 110 via a network 140. The network 140 may be a wired or wireless network(s) or a combination of wired and wireless networks that connect one or more elements of the system 100. Each of the client devices 130A-130N may be a type of personal, business or handheld computing device having or being connected to input/output elements that enable a user to interact with various applications (e.g., application 112 or application 134). Data from user's interactions with the various applications may be collected in the form of telemetry logs and used by the help documentation management system 114 to generate and maintain help documentation. One or more of the client devices 130A-130N may be utilized by a help documentation curator to review, revise and/or approve automatically generated help documentation. Examples of suitable client devices 130 include but are not limited to personal computers, desktop computers, laptop computers, mobile telephones, smart phones, tablets, phablets, smart watches, wearable computers, gaming devices/computers, televisions; and the like. The internal hardware structure of a client device is discussed in greater detail with respect to FIGS. 5 and 6.

One or more of the client devices 130A-130N may include a local application 134. The applications 134A-134N may be software programs executed on the client device that configures the device to be responsive to user input to allow a user to perform various functions within the applications 134A-134N. Data relating to each of the user's interactions with the applications 134A-134N may be collected and stored in telemetry logs. Examples of suitable applications include, but are not limited to, a word processing application, a spreadsheet application, a presentation application, a communications application, and the like. Applications 134A-134N may also be representative of an application used to review, revise and approve help documentation for use in another application.

In some examples, the application a user interacts with and from telemetry data is collected is executed on the server 110 (e.g., application 112) and provided via an online service. In some implementations, web applications communicate via the network 140 with a user agent 132A-132N, such as a browser, executing on the client devices 130A-130N. The user agent 132A-132N may provide a user interface that allows the user to interact with the application 112.

FIG. 1B depicts an example data flow between some of the elements of the example system 100. The help documentation management system 114 may include an action path identification unit 150, an action label identification unit 152, a help documentation management unit 154, and a help documentation generation model 156. Telemetry data 136 may be collected from use of an application by a number of users. Telemetry data may include telemetry logs that are collected by many software applications to keep track of the status of the applications and identify potential failures, etc. These telemetry logs often include a history of all actions taken by a user in applications. The actions may be stored using command identifiers such as toolbar command identifiers (TCIDs) or any identifier used by a software application to identify specific commands and/or tasks in the applications. Each TCID may correspond with an interaction with the application (e.g., clicking on a UI button or opening a menu). Actions in an application that do not correspond with a TCID may have other identifiers. For example, selecting text in Microsoft Word® by clicking on a text portion, dragging and then releasing the pointer may not be associated with a TCID but can be identified with other identifiers. For applications that do not utilize command identifiers, metadata regarding the use of the application may be used and stored in the telemetry logs to determine actions taken within the application.

The telemetry logs may contain a list of user interactions in a chronological order for given users (e.g., for some or all users of a software application). For application having a large number of users, the resulting telemetry logs may be very large in size. Thus, the telemetry logs may be organized by time (e.g., a telemetry log per 24-hour). These telemetry logs may be stored in a storage medium such as the data store 122 as telemetry data 136 and one or more of the telemetry logs may be retrieved and provided to the action path identification unit 150.

The action path identification unit 150 may examine the telemetry data 136 for a given time period to identify specific actions taken in the applications. The actions may be features offered by the application. For example, for a word processing applications, the actions may include, copy, paste, cut, insert table, insert equation, change font, and the like. The action path identification unit 150 may have access to a list of actions/features offered by an application for which help documentation should be generated. The list may be made and/or updated manually or may be created automatically. In some implementations, the list of actions for which help documentation should be created is derived from analyses of the telemetry logs. For example, actions that are performed more than a certain number of times or make up more than a certain percentage of actions taken within a given time period, may be identified as being popular actions that require help documentation.

Once an action is identified as requiring help documentation, the action path identification unit 150 may analyze the telemetry data 136 to determine what other action/TCIDs were performed to arrive at the identified action. This may involve analyzing actions taken immediately prior to the identified action to determine the action path that was taken to arrive at the identified action. For example, for inserting a table, the action path may include clicking on the insert tab first, clicking on the table UI button next, then selecting the number of columns/rows for the table by moving the pointer over the displayed table and finally clicking on the displayed table to insert the table in the document. Because many applications offer a variety of methods for arriving at a certain action (e.g., different intermediate menu options such as toolbar menu, context menu, etc.), the telemetry logs may include different action paths for a given action. To ensure that the help documentation provides accurate/efficient steps for arriving at an action, the action path identification unit 150 may analyze the identified action paths for the action and select the shortest and/or most frequently used chronological path for the action. This may involve analyzing all the identified actions path for the action to identify the shortest and/or most frequently used path. In some instances that shortest path may also be the most frequently used path. In other cases, the shortest path may be different from the most frequently used path. That may be because users are not familiar with certain menu features and/or a longer path is more convenient. When the shortest path is not the same as the most frequently used path, other parameters may be taken into account in selecting one of the paths. These parameters include the amount of time it takes to achieve success with the path, the number of steps taken in each path or a weighted combination of the two. In some implementations, a help documentation is generated from both the shortest path and the most frequently path. The help documentation may provide the paths as alternative ways for performing the action.

Once an action path is selected for performing an action, the action path may be provided to the action label identification unit 152 for identifying an action label for each action in the action path. The action label identification unit 152 may utilize the TCIDs or other type of identifiers of the actions in the action path to identify an action type, UI element involved, UI element label and/or images present in the UI for each action in the action path. In some implementations, the action type, UI element involved, UI element label and/or images present may be retrieved from application data 142. The application data 142 may include source code and software resources for the application. The action label identification unit 152 may receive and examine the application data 142 to retrieve information about each action in the action path. For example, the first action in the above example of inserting a table is clicking on the insert tab. The action path identification unit 150 may identify this action by the TCID associated with the insert tab. That TCID may then be used by the action label identification unit 152 to look up information about the TCID in the application data 142. The application data 142 may include information such as the TCID being associated with an insert action, with a UI element in the top toolbar having the label “Insert.” By retrieving the action type and/or label, the action label identification unit 152 can convert an action path consisting of TCIDs to an action path consisting of action types/labels that can be used to generate instructions in a help document.

When the action types/labels have been determined, the action label identification unit 152 may transmit the action types/labels for the selected action path to the help documentation generation model 156 to generate a help documentation based on the action path. The help documentation generation model 156 may be a trained ML model that is trained to generate instructions for performing an action based on an identified action path. In some implementations, the help documentation generation model 156 is a prompt-based learning model. In an example, the help documentation generation model 156 is a Generative Pre-trained Transformer 3 (GPT3) model. To use the help documentation generation model 156 to generate a help documentation (e.g., a help article), the original input (e.g., action path labels) are modified using a template to convert the input into textual string prompts. The textual string prompts are then used by the model to generate a set of instructions for performing the action associated with the action path. In this manner, the trained help documentation generation model 156 can quickly and efficiently generate help documentation associated with actions taken in an application. In an example implementation, a trained help documentation generation model 156 was able to generate about 800 help articles in a few minutes. This significantly increases efficiency and significantly reduces the amount of human intervention required, thus resulting in reduced costs. Furthermore, this process results in help documentations that are consistent in format.

The resulting help documentation generated by the help documentation generation model 156 may be provided as help documentation output 158. The help documentation output 158 may consist of a help article or any other kind of documentation that provides instructions/information on how to perform an action in a given application. The instructions may include images (e.g., UI element) of menu options that need to be selected or otherwise interacted with to perform the desired action. The help documentation output 158 may also include information about the action path used to generate the help documentation. The information about the action path may be stored as metadata and/or properties of the help documentation.

In one implementation, the help documentation output 158 is directly transmitted to the help documentation library 138 for storage and use with the application. In other implementations, the automatically generated help documentation output 158 is transmitted to a help documentation review team for review and final approval. This may entail a review of the help documentation by an expert to ensure the content is accurate, efficient and/or correctly conveys the necessary steps for performing the action. While this may involve some human intervention, the amount of time required for reviewing an already generated help documentation is minimal. When the new help documentation is stored in the help documentation library 138, information associated with the help documentation may be added to a database containing a list of help documentations for an application. This may provide an index for a quick look up of help documentations when needed and may include keywords for the action for which the help documentation was generated and information about the location at which the help documentation is stored.

The help documentation library 138 may be a dataset for storing help documentations for one or more applications. In some implementations, the help documentation library 138 is stored in a data store such as the data store 122. In an example, the help documentation library 138 is stored in the same storage medium as the application data 142 (e.g., with the source code). In a system having multiple applications, each application may have its own library of help documentations.

Software applications often undergo regular changes and updates. Some of these changes may relate to specific features. Other may be associated with alterations in the UI screens. Either of those revisions may result in changes in the action path for performing an action. For example, if the location of the menu button for inserting a table changes from being displaying under the Insert tab to being displayed under the Home tab, the action path for arriving at the menu button will also change. Currently, when applications undergo updates, manual support is often needed to review and revise current help documentations. This is a labor intensive and complex undertaking as a small change in a UI can result in changes in many action paths and thus numerous help documentations. Furthermore, updates occur frequently, and many applications offer different versions to different groups of users, further complicating the process of maintaining help documentation. To address these technical problems, the technical solutions provided herein make use of a help documentation management unit 154 to automatically detect when changes to help documentations are needed.

The help documentation management unit 154 may examine the action paths identified by the action path identification unit for a recognized action and compare those action paths to action paths of the help documentations in the help documentations library 138 to determine if the action path has changed since the help documentation was generated. In some implementations, this determination may take into account other factors such as the version number of the application for which the current action path was identified verses the version number of the application for which the help documentation was generated, the amount of time passed since the help documentation was generated, the amount of time passed since the action path was first identified as being different than the action path used to generate the help documentation and the like. In an example, to result in a change in the help documentation, the newly identified action path should meet a threshold number (e.g., a frequency with which the new action is used by the users, the frequency with which the previous action path is used by users, etc.). When it is determined that the action path has indeed changed since the help documentation was generated, the help documentation management unit 154 may transmit information about the new action path, associated action labels, and/or the previously generated help documentation to the help documentation generation model 156 to regenerate the help documentation with the updated information.

In some implementations, in addition to monitoring the help documentation library 138 to determine the need for updated help documentations, the help documentation management unit 154 also monitors the help documentation library 138 as well as the output from the action path identification unit 150 and action label identification unit 152 to identify when a need for a help documentation for a new action arises. For example, after an application goes through an initial help documentation generation, which may occur offline, the help documentation management unit 154 may continue monitoring the telemetry data 136 and help documentation library 138 to determine when an action for which help documentation was not generated in the initial stage may require documentation. This may occur, for example, when changes are made to an application to introduce a new feature, or when changes in user habits occur. For example, users may begin learning about and more frequently using a previously available feature. This may result in the telemetry data 136 indicating that the action associated with the feature occurs frequently in the application, thus signaling a need for having help documentation for the action. The help documentation management unit 154 may then examine the help documentation library to determine if a corresponding help documentation exists for the action, and if not, providing information about the action to the help documentation generation model 156 to generate the help documentation. In some implementations, upon determining the need for generating a help documentation for a new feature, in addition to or instead of sending an indication to the help documentation generation model 156, the help documentation management unit 154 may transmit a notification to a help documentation team to inform the team of the need for help documentation for the action. The team may then transmit a request to the help documentation generation model 156 to automatically generate the help documentation or may generate the help documentation manually.

FIG. 1C depicts how one or more ML models used by the help documentation management system 114 may be trained by using the training mechanism 116. The training mechanism 116 may use supervised and/or unsupervised training techniques. The supervised training may make use of labeled training data sets stored in the data store 122 to provide initial and ongoing training to the help documentation generation model 156.

In some implementations, the help documentation generation model 156 is trained using a training data 160 which includes existing help documentation (e.g., help articles) written about actions in an application. The training data 160 may include a small subset of help articles that have been written (e.g., manually) and selected for their desired formatting and proper language used. In addition to the help articles, each help article may be labeled with an associated action path and action labels for the actions in the action path. This training data 160 may then be used by the training mechanism 116 to perform prompt-based training of a GPT3 model. Unlike traditional supervised learning, which trains a model to take in an input x and predict an output y, prompt-based learning may be based on language models that model the probability of text directly. In some implementations, during the training, only action name (e.g., command name) and action label (e.g., command label) are used as labels for the training data. In other implementations, additional data such as the type of user interface element (e.g., menu button, combo box, list, gallery, etc.) and/or other information about the action may be provided as labels for one or more actions in each action path.

In some implementations, to provide ongoing training, the training mechanism 116 may use training data sets received as out of the ML models. For example, after the model is trained and used, help documentations generated by the model may be provided as part of the training data to provide ongoing training. Furthermore, data may be provided from the training mechanism 116 to the data store 122 to update one or more of the training datasets in order to provide updated and ongoing training. Additionally, the training mechanism 116 may receive training data such as knowledge from other pre-trained mechanisms.

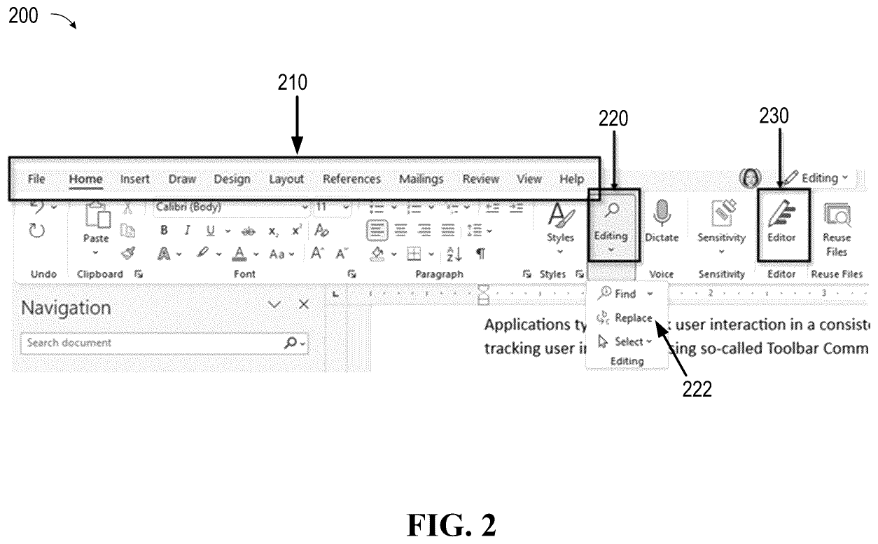

FIG. 2 depicts an example UI screen 200 of different types of UI elements used to perform an action in an application. An application such as a word processing application may include a toolbar menu 210 displaying root menu action, UI elements associated with intermediate actions such as menu option 220 displayed underneath each tab of the toolbar menu 210, and UI elements associated with leaf/intended action such as menu option 230. A root menu action may refer to an initial action (e.g., first step) that needs to be taken to arrive at an intended action. For example, to view the UI elements under the Home tab of the toolbar menu 210, a user would first need to press on the Home tab (unless the screen is already displaying the Home tab). Intermediate actions may point to actions that need to occur after the root action but prior to the intended action. For example, menu option 220 needs to be selected to display the Replace menu option 222. An intended action may refer to the ultimate action the user desires to take in the application. For example, the menu option 230 may be the intended action for a user desiring to display the Editor pane. To arrive at the intended action of displaying the Editor pane, the root action of selecting the Home tab may first need to occur. For some intended actions, only a root action and the intended action (e.g., two steps) may be required. For others, there may be a root action and one or more intermediate actions until the user arrives at the intended action. As depicted in UI screen 200, actions in the application may be associated with a corresponding UI element and/or action labels. The action labels and corresponding UI elements may be retrieved and used in generating the help documentations.

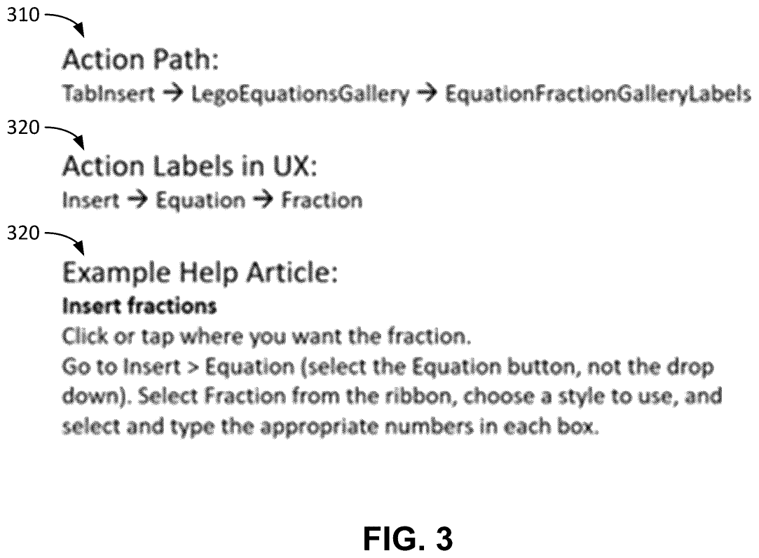

FIG. 3 depicts an example action path, corresponding action labels and the resulting help documentation generated. An action path 310 for inserting a fraction equation may include clicking on the insert tab (TabInsert), selecting the equations gallery menu button (LegoEquationsGallery) and then selecting the fraction menu options (EquationFractionGalleryLabels). Once the action path 310 has been identified, source code documentation may be used to find the action labels in the UI for each of the actions in the action path. The action labels 320 include insert, equation, and fraction. As depicted, the action path 310 and 320 list the actions in the order in which they need be performed. This assists the help documentation generation model to generate the steps required for performing the intended action. Thus, the action labels 320 may be used to generate the example help article 330. The help article 330 includes a title (which may be derived from keywords associated with the intended action), and a list of steps, in a chronological order, that need to be performed to arrive at the intended action. As depicted, in addition to the action labels, the help article includes instruction on how to interact with each action (e.g., go to, select, choose, type, etc.). Furthermore, the help article includes actions that are not directly associated with the action labels such as “click or tap where you want the fraction.” This information may be derived from the telemetry logs based on metadata or other information that lists actions that are not directly associated with TCIDs or commands but are still identified in the telemetry logs using specific identifiers. In some implementations, actions not directly associated action labels are determined by the help documentation generation model based, based on previous training. The resulting help documentation is a concise and accurate set of instructions on how to arrive at an intended action quickly.

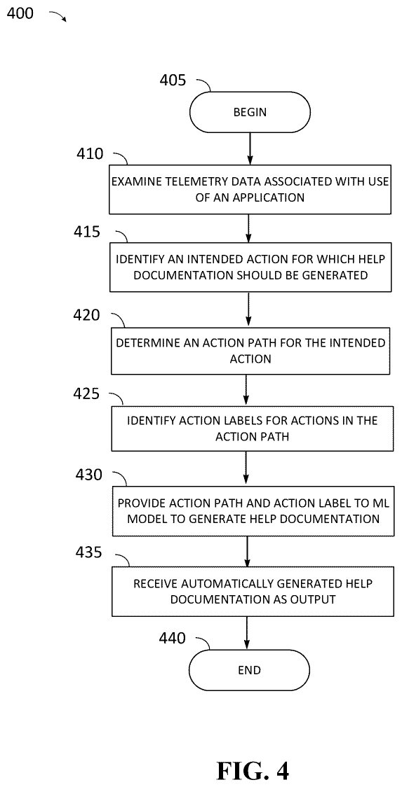

FIG. 4 is a flow diagram depicting an exemplary method 400 for automatically generating help documentation for software applications. One or more steps of the method 400 may be performed by a help documentation management system such as the help documentation management system 114 of FIGS. 1A-1B. The method 400 may begin, at 405, and proceed to examine telemetry data associated with various users' use of an application, at 410. This may occur, for example, when an application is initially submitted for generating help documentation. For example, this may occur for a new application or for an application that has not had updated help recommendation for a while. The process may be initiated by a user, for example, upon submitting a request for generating help documentation for a given application to a help documentation management system. Furthermore, the process may be initiated when an application is updated or as part of ongoing maintenance of help documentation for an application. To examine the telemetry data, one or more telemetry logs for given time periods may be retrieved from a data store.

Once the telemetry data is examined, an intended action for which help documentation should be generated may be identified, at 415. This may be determined based on the number or percentage of times the intended action occurs in the telemetry data, based on whether a help documentation already exists for the intended action, and/or the length of time since the help documentation was last updated (e.g., has it been updated since the last update to the application).

After an intended action is identified, method 400 may proceed to determine an action for the intended action, based on the telemetry data, at 420. The action path may be the shortest and/or the most frequently used action path for arriving at the intended action. The action path may include one or more of the actions taken in the application to perform the intended action and may include TCIDs or other command identifiers. Once the action path is determined, method 400 may proceed to identify action labels for the actions in the action path, at 425. The action labels may be labels associated with each action in the action path and may be derived from the source code and/or the UI associated with the application.

Once the action path and action labels are identified, they may be provided to a trained ML model for automatically generating a help documentation for the intended action based on the action path and/or action labels, at 430. The ML model may then automatically generate the help documentation, before providing the generated help documentation as an output, at 435. The help documentation may be provided directly for storage in a help documentation library and use in the application. Alternatively, the help documentation may be provided for review to a help documentation review team, before being approved for use. Once the help documentation is provided, method 400 may end, at 440.

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as client devices, native application provider, web servers, server clusters, external services, and other servers. A representative hardware layer 504 includes a processing unit 506 and associated executable instructions 508. The executable instructions 508 represent executable instructions of the software architecture 502, including implementation of the methods, modules and so forth described herein.

The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular system. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine depicted in block diagram 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement methods or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in

FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660 and/or position components 662, among a wide array of other environmental sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 662 may include, for example, location sensors (for example, a Global Position System (GPS) receiver), altitude sensors (for example, an air pressure sensor from which altitude may be derived), and/or orientation sensors (for example, magnetometers). The motion components 658 may include, for example, motion sensors such as acceleration and rotation sensors. The environmental components 660 may include, for example, illumination sensors, acoustic sensors and/or temperature sensors.

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 662, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:
Item 1. A data processing system comprising:
   a processor; and
   a memory in communication with the processor, the memory comprising executable instructions that, when executed by the processor, cause the data processing system to perform functions of:
   examining telemetry data associated with a plurality of users' use of an application;
   identifying from the telemetry data an intended action for which a help documentation should be generated;
   determining from the telemetry data an action path in the application for arriving at the intended action, the action path including one or more actions taken before arriving at the intended action;
   identifying an action label for at least one of the one or more actions;
   providing at least one of the action path and the action label to a trained machine-learning (ML) model for automatically generating the help documentation; and
   receiving from the trained ML model the automatically generated help documentation as an output.
Item 2. The data processing system of item 1, wherein the automatically generated help documentation is provided for storage in a help documentation library.
Item 3. The data processing system of items 1 or 2, wherein the automatically generated help documentation is provided for manual review and approval.
Item 4. The data processing system of any preceding item, wherein the trained ML model is a prompt-based model.
Item 5. The data processing system of any preceding item, wherein the action label is derived from application data associated with the application.
Item 6. The data processing system of any preceding item, wherein, based on the telemetry data, the action label is a shortest action path for arriving at the intended action.
Item 7. The data processing system of any preceding item, wherein, based on the telemetry data, the action label is a most frequently used action path for arriving at the intended action.
Item 8. The data processing system of any preceding item, wherein the executable instructions, when executed by the processor, further cause the data processing system to perform functions of:
   monitoring the telemetry data and a library of existing help documentation to determine that the action path associated with an existing help documentation has changed;
   upon determining that the action path has changed, identifying the action label for at least one of the one or more actions in the changed action path, and
   providing at least one of the changed action path and the action label to the trained machine-learning model for automatically generating a new help documentation for the intended action.
Item 9. The data processing system of any preceding item, wherein the executable instructions, when executed by the processor, further cause the data processing system to perform functions of:
   monitoring the telemetry data and a library of existing help documentation to determine that help documentation should be generated for a new intended action; and
   upon determining that help documentation should be generated for the new intended action, providing a notification to a user.
Item 10. A method for automatically generating help documentation for an application comprising:
   examining telemetry data associated with a plurality of users' use of the application;
   identifying from the telemetry data an intended action for which a help documentation should be generated;
   determining from the telemetry data an action path in the application for arriving at the intended action, the action path including one or more actions taken before arriving at the intended action;
   identifying an action label for at least one of the one or more actions;
   providing at least one of the action path and the action label to a trained machine-learning (ML) model for automatically generating the help documentation; and
   receiving from the trained ML model the automatically generated help documentation as an output.
Item 11. The method of item 10, wherein the automatically generated help documentation is provided for storage in a help documentation library.
Item 12. The method of any of items 10 or 11, wherein the automatically generated help documentation is provided for manual review and approval.
Item 13. The method of any of items 10-12, wherein the trained ML model is a prompt-based model that is trained to predict probability of text.
Item 14. The method of any of items 10-13, wherein the action label is derived from source code associated with the application.
Item 15. The method of any of items 10-14, further comprising:
   monitoring the telemetry data and a library of existing help documentation to determine that the action path associated with an existing help documentation has changed;
   upon determining that the action path has changed, identifying the action label for at least one of the one or more actions in the changed action path, and
   providing at least one of the changed action path and the action label to the trained machine-learning model for automatically generating a new help documentation for the intended action.
Item 16. The method of any of items 10-15, further comprising:
   monitoring the telemetry data and a library of existing help documentation to determine that help documentation should be generated for a new intended action; and
   upon determining that help documentation should be generated for the new intended action, providing a notification to a user.
Item 17. A non-transitory computer readable medium on which are stored instructions that, when executed, cause a programmable device to perform functions of:
   examining telemetry data associated with a plurality of users' use of an application; identifying from the telemetry data an intended action for which a help documentation should be generated;
   determining from the telemetry data an action path in the application for arriving at the intended action, the action path including one or more actions taken before arriving at the intended action;
   identifying an action label for at least one of the one or more actions;
   providing at least one of the action path and the action label to a trained machine-learning (ML) model for automatically generating the help documentation; and
   receiving from the trained ML model the automatically generated help documentation as an output.
Item 18. The non-transitory computer readable medium of item 17, wherein the trained ML model is a prompt-based model.
Item 19. The non-transitory computer readable medium of any of items 17 or 18, wherein the instructions when executed, further cause a programmable device to perform functions of:
   monitoring the telemetry data and a library of existing help documentation to determine that the action path associated with an existing help documentation has changed;
   upon determining that the action path has changed, identifying the action label for at least one of the one or more actions in the changed action path, and
   providing at least one of the changed action path and the action label to the trained machine-learning model for automatically generating a new help documentation for the intended action.
Item 20. The non-transitory computer readable medium of any of items 17-19, wherein automatically generating a new operating procedure for resolving the issue includes:
   monitoring the telemetry data and a library of existing help documentation to determine that help documentation should be generated for a new intended action; and
   upon determining that help documentation should be generated for the new intended action, providing a notification to a user.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

1. A data processing system comprising:
a processor; and
a memory in communication with the processor, the memory comprising executable instructions that, when executed by the processor, cause the data processing system to perform functions of:
providing telemetry data associated with a plurality of users' use of an application to an action path identification unit;
detecting from the telemetry data, using the action path identification unit, performance of an action in the application, the action being on a list of actions that require help documentation that provides guidance on how to perform the action in the application;
determining from the telemetry data, using the action path identification unit, an action path in the application for arriving at the action, the action path including one or more steps taken before arriving at the action;
retrieving a source code for the application to identify, using an action label identification unit, an action label for each one of the one or more steps, the action label being at least one of an action type or a user interface element associated with the step;
providing at least one of the action path and the action label to a trained help documentation generation machine-learning (ML) model for automatically generating the help documentation for performing the action; and
automatically generating, using the trained help documentation generation ML model, an automatically generated help documentation which includes instructions for performing the action in the application.

2. The data processing system of claim 1, wherein the automatically generated help documentation is provided for storage in a help documentation library.

3. The data processing system of claim 1, wherein the automatically generated help documentation is provided for manual review and approval.

4. The data processing system of claim 1, wherein the trained help documentation generation ML model is a prompt-based model.

5. The data processing system of claim 1, wherein the action label is derived from application data associated with the application.

6. The data processing system of claim 1, wherein, based on the telemetry data, the action path is a shortest action path for arriving at the action.

7. The data processing system of claim 1, wherein, based on the telemetry data, the action path is a most frequently used action path for arriving at the action.

8. The data processing system of claim 1, wherein the executable instructions, when executed by the processor, further cause the data processing system to perform functions of:
monitoring the telemetry data and a library of existing help documentation to determine that the action path associated with an existing help documentation has changed;
upon determining that the action path has changed, identifying the action label for at least one of the one or more steps in the changed action path, and
providing at least one of the changed action path and the action label to the trained help documentation generation ML model for automatically generating a new help documentation for the action.

9. The data processing system of claim 1, wherein the executable instructions, when executed by the processor, further cause the data processing system to perform functions of:
monitoring the telemetry data and a library of existing help documentation to determine that a new intended action is on the list of actions that require help documentation; and
upon determining that the new intended action is on the list of actions that require help documentation, providing a notification to a user.

10. A method for automatically generating help documentation for an application comprising:
providing telemetry data associated with a plurality of users' use of the application to an action path identification unit;
detecting from the telemetry data, using the action path identification unit, performance of an action in the application, the action being on a list of actions that require help documentation that provides guidance on how to perform the action in the application;
determining from the telemetry data, using the action path identification unit, an action path in the application for arriving at the action, the action path including one or more steps taken before arriving at the action;
retrieving a source code for the application to identify, using an action label identification unit, an action label for each one of the one or more steps, the action label being at least one of an action type or a user interface element associated with the step;
providing at least one of the action path and the action label to a trained help documentation generation machine-learning (ML) model for automatically generating the help documentation for performing the action; and
automatically generating, using the trained help documentation generation ML model, an automatically generated help documentation which includes instructions for performing the action in the application.

11. The method of claim 10, wherein the automatically generated help documentation is provided for storage in a help documentation library.

12. The method of claim 10, wherein the automatically generated help documentation is provided for manual review and approval.

13. The method of claim 10, wherein the trained help documentation generation ML model is a prompt-based model that is trained to predict probability of text.

14. The method of claim 10, wherein the action label is derived from the source code for the application.

15. The method of claim 10, further comprising:
monitoring the telemetry data and a library of existing help documentation to determine that the action path associated with an existing help documentation has changed;
upon determining that the action path has changed, identifying the action label for at least one of the one or more steps in the changed action path, and
providing at least one of the changed action path and the action label to the trained help documentation generation ML model for automatically generating a new help documentation for the action.

16. The method of claim 10, further comprising:
monitoring the telemetry data and a library of existing help documentation to determine that that a new intended action is on the list of actions that require help documentation; and
upon determining that the new intended action is on the list of actions that require help documentation, providing a notification to a user.

17. A non-transitory computer readable medium on which are stored instructions that, when executed, cause a programmable device to perform functions of:
providing telemetry data associated with a plurality of users' use of an application to an action path identification unit;
detecting from the telemetry data, using the action path identification unit, performance of an action in the application, the action being on a list of actions that require help documentation that provides guidance on how to perform the action in the application;
determining from the telemetry data, using the action path identification unit, an action path in the application for arriving at the action, the action path including one or more steps taken before arriving at the action;
retrieving a source code for the application to identify, using an action label identification unit, an action label for each one of the one or more steps, the action label being at least one of an action type or a user interface element associated with the step;
providing at least one of the action path and the action label to a trained help documentation generation machine-learning (ML) model for automatically generating the help documentation for performing the action; and
automatically generating, using the trained help documentation generation ML model, an automatically generated help documentation which includes instructions for performing the action in the application.

18. The non-transitory computer readable medium of claim 17, wherein the trained help documentation generation ML model is a prompt-based model.

19. The non-transitory computer readable medium of claim 17, wherein the instructions when executed, further cause a programmable device to perform functions of:
monitoring the telemetry data and a library of existing help documentation to determine that the action path associated with an existing help documentation has changed;
upon determining that the action path has changed, identifying the action label for at least one of the one or more steps in the changed action path, and
providing at least one of the changed action path and the action label to the trained help documentation generation ML model for automatically generating a new help documentation for the action.

20. The non-transitory computer readable medium of claim 17, wherein automatically generating help documentation includes:
monitoring the telemetry data and a library of existing help documentation to determine that that a new intended action is on the list of actions that require help documentation; and
upon determining that the new intended action is on the list of actions that require help documentation, providing a notification to a user.
